(19) United States
(12) Patent Application Publication
(10) Pub. No.: US 2010/0086790 A1
(43) Pub. Date: Apr. 8, 2010

(54) Layer system

(76) Inventors: Eckart Schumann, Mulheim an der Ruhr (DE); Ramesh Subramanian, Oviedo, FL (US); Berit Wessler, Regensburg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/517,089

(22) PCT Filed: Sep. 7, 2007
(86) PCT No.: PCT/EP2007/059361

§ 371 Date: Dec. 8, 2009

(30) Foreign Application Priority Data
Dec. 7, 2006 (EP) 06025368.9

(51) Int. Cl. B32B 15/04; B32B 19/00; B32B 19/04; C04B 35/48

(52) U.S. Cl. 428/457; 428/697; 428/701; 501/103

(57) ABSTRACT

A layer system including a substrate on which a first layer is positioned is provided. The first layer includes a thermographic material. The thermographic material is a pyrochlore phase doped with at least one rare earth material. The rare earth material is selected from the group europium, terbium, erbium, dysprosium, samarium, holmium, praseodymium, ytterbium, neodymium, and thulium. A method of a layer system is also provided.

### CROSS REFERENCE TO RELATED APPLICATIONS

This application is the US National Stage of International Application No. PCT/EP2007/059361, filed Sep. 7, 2007 and claims the benefit thereof. The International Application claims the benefits of European application No. 06025368.9 EP filed Sep. 7, 2006, both of the applications are incorporated by reference herein in their entirety.

### FIELD OF INVENTION

The invention relates to a layer system which has thermal barrier properties.

### BACKGROUND OF INVENTION

Such a layer system comprises a substrate consisting of a metal alloy based on nickel, cobalt or iron. Products of this type are used especially as components of gas turbines, in particular as gas turbine blades or heat shields. Such components are exposed to a hot gas flow of aggressive combustion gases. They must therefore be able to withstand strong heating. It is furthermore necessary for these components to be oxidation- and corrosion-resistant. Especially moving components, for example gas turbine blades, but also static components, are furthermore subject to mechanical requirements. The power and efficiency of a gas turbine, in which components exposable to hot gas are employed, increase with a rising operating temperature. In order to achieve a high efficiency and a high power, those gas turbine components which are particularly exposed to high temperatures are coated with a ceramic material. This acts as a thermal barrier layer between the hot gas flow and the metal substrate. In this context, modern components usually comprise a plurality of coatings which respectively fulfill specific functions. The system is therefore a multilayer system.

Since the power and efficiency of gas turbines increase with a rising operating temperature, attempts are constantly being made to permit higher temperatures by improving the coating system, and thus achieve a higher performance of gas turbines.

EP 0 992 603 A1 discloses a thermal barrier layer system of gadolinium oxide and zirconium oxide with a cubic crystal structure.

EP 1 321 542 A1 discloses a metal substrate, which is coated with a ceramic layer that comprises hafnium oxide.

EP 1 505 042 A2 describes a thermal barrier layer based on zirconium oxide, which comprises a trivalent oxide and at least one pentavalent oxide.

U.S. Pat. No. 6,015,630 describes the thermal barrier layer which comprises yttrium oxide-aluminum garnet; the yttrium may be partially replaced by a rare earth element.

Thermal barrier layers of yttrium oxide-stabilized zirconium oxide with a rare earth oxide are furthermore described in EP 1 550 644 A1, U.S. Pat. No. 6,730,918, EP 1 249 515 A2, EP 1 550 744 A1, EP 1 536 039 A1 and EP 0 825 271 A1.

One possibility for measuring surface temperatures of thermal barrier layers consists in using thermographic light-limiting substances. A thermal barrier layer with an embedded thermographic indicator material and a method for determining the temperature of the thermal barrier layer are described, for example, in EP 1 105 550 B1. In order to determine the temperature of the thermal barrier layer, the indicator material is stimulated to fluoresce by means of a pulsed laser. After the stimulation pulse is switched off, the intensity of the fluorescence spectrum falls off exponentially with a characteristic time constant t. For example yttrium aluminum garnet doped with terbium (Tb), i.e. (YAG:Tb), exhibits a decrease of the characteristic time constant t between 700 and 1000° C. By measuring the time constant, it is possible to establish the temperature of the indicator material and therefore of the thermal barrier layer in which it is embedded, so long as suitable calibration has been carried out. Under certain circumstances, various lines of the emission spectrum may have different decay constants, which may also have different temperature dependencies. Besides YAG:Tb, EP 1 105 550 also mentions yttrium aluminum garnet doped with dysprosium (Dy), i.e. (YAG:Dy), and yttrium-stabilized zirconium oxide (YSZ) with one or more rare earth elements.

Instead of the time decay behavior of the emission intensity of the indicator material, the intensity ratio of two emission wavelengths may also be employed in order to determine the temperature of the indicator material, and therefore the temperature of the thermal barrier layer. The intensity ratio approximately depends linearly on the temperature of the indicator material—i.e. on the temperature of the thermal barrier layer in which the indicator material is embedded. Temperature measurement via the intensity ratio is likewise described in EP 1 105 550 B1.

### SUMMARY OF INVENTION

It is an object of the invention to provide a material which has good thermal barrier properties and good bonding to a substrate, and therefore a long lifetime of the overall layer system, and which at the same time permits temperature measurement.

The object is achieved by a layer system as claimed in the claims and the use of a mixture as claimed in the claims.

The dependent claims describe further advantageous measures, which may advantageously be combined in any desired way.

The present invention relates to a layer system that comprises a substrate, on which there is a first layer that comprises a thermographic material, the thermographic material being a pyrochlore phase doped with at least one rare earth material.

The term thermographic material is intended to mean a photoluminescent material, a material which can be stimulated for example by UV radiation to emit light, in which the intensity and/or the decay time of the stimulated luminescent radiation depends or depend on the temperature of the photoluminescent material. In particular, the intensity may also depend on other factors, for example the concentration of the rare earth material as a dopant.

The thermographic material, i.e. the pyrochlore phase, is thus constructed from a host material and a rare earth dopant. The rare earth dopant is embedded as a cation in the host material, and is used as an activator of the thermographic light-emitting substance. The thermographic light-emitting substance therefore comprises the host lattice and the rare earth cation as an activator.

The first layer's pyrochlore phase doped with a rare earth material advantageously combines thermal barrier properties with thermographic properties. The thermographic material makes it possible to measure the temperature of the thermal barrier layer through stimulation of luminescence by means of radiation, for example by means of UV radiation. With the aid of temperature dependency in the decay behavior of the luminescent radiation, for example, the temperature of the first layer i.e. the pyrochlore phase can be deduced from a measurement of the decay behavior.

The thermographic material also makes it possible to detect wear in the thermal barrier layer. In the event of wear, the thermographic material becomes eroded. Wear, i.e. the absence of thermographic material, may then be detected on the basis of the luminescence being reduced or even entirely absent at the worn site.

The rare earth dopant is advantageously selected from the group consisting of Eu (europium), Tb (terbium), Er (erbium), Dy (dysprosium), Sm (samarium), Ho (holmium), Pr (praseodymium), Yb (ytterbium), Nd (neodymium) and Tm (thulium). The rare earth dopant as an oxide, i.e. for instance as Eu, Tb, Er, Dy, Sm, Ho, Pr, Yb, Nd or Tm oxide, may be made to react with the host lattice material in order to embed it as a rare earth cation in the host material. Owing to the advantageous temperature-dependent decay behavior of their luminescent radiation, Dy and Tm are particularly suitable as dopants.

The doping concentration of the rare earth material preferably lies in the range of between 0.005% and 7%, particularly in the range of between 0.1% and 4%.

However, not only the dopant, but also the pyrochlore phase itself may comprise a rare earth material or several rare earth materials, for instance Gd and/or Dy and/or Tm and/or Tb, etc. The thermographic material may then in particular have the form (A,B)ᵥ(CₓD_{y})O_{z} with x+y≈2 and z≈7, in particular with v=2, x+y=2 and z=7, more particularly with v=2, x+y=2 and z=7, where A stands for at least one rare earth material of the pyrochlore phase, B stands for at least one rare earth material as a dopant, C stands for Zr and D stands for Hf.

In a particular refinement of the invention, the pyrochlore phase comprises (Gd,B)₂Hf₂O₇, i.e. gadolinium hafnate (Gd₂Hf₂O₇) which is doped with at least one rare earth material B.

As an alternative to this, the pyrochlore phase may also comprise (Gd,B)₂Zr₂O₇, i.e. gadolinium zirconate (Gd₂Zr₂O₇) which is doped with at least one rare earth material B. Mixtures of doped gadolinium hafnate and doped gadolinium zirconate are moreover possible.

The two said particular doped pyrochlore phases are especially suitable for the construction of thermal barrier layers owing to their good thermal barrier properties.

In a refinement of the invention, the layer system comprises a metal bonding layer which is arranged between the substrate and the first layer. The metal bonding layer advantageously consists of an MCrAlX alloy, where M stands for a metal, in particular for iron (Fe), nickel (Ni) or cobalt (Co), and X stands for at least one rare earth element, yttrium (Y) or silicon (Si). The MCrAlX alloy advantageously consists of 24-26 wt % cobalt, from 16 to 18 wt % chromium, from 9.5 to 11 wt % aluminum, from 0.3 to 0.5 wt % yttrium and from 0.5 to 2.0 wt % rhenium, the remainder being nickel. As an alternative, the MCrAlX alloy consists of 11-13 wt % cobalt, from 20 to 22 wt % chromium, from 10.5 to 11.5 wt % aluminum, from 0.3 to 0.5 wt % yttrium and from 1.5 to 2.5 wt % rhenium, the remainder being nickel.

Instead of nickel, the MCrAlX alloy may also be based on cobalt. A cobalt-based MCrAlX alloy may consist of from 29 to 31 wt % nickel, from 27 to 29 wt % chromium, from 7 to 9 wt % aluminum, from 0.5 to 0.7 wt % yttrium and from 0.6 to 0.8 wt % silicon, the remainder being cobalt. In an alternative variant, the MCrAlX alloy consists of from 27 to 29 wt % nickel, from 23 to 25 wt % chromium, from 9 to 11 wt % aluminum and from 0.5 to 0.7 wt % yttrium, the remainder being cobalt.

The first layer is advantageously used as a thermal barrier layer, in particular as a substrate for turbine components exposed to a hot gas. The layer system may also comprise an undoped thermal barrier layer, for example a stabilized zirconium oxide layer, in particular an yttrium-stabilized zirconium oxide layer, or an undoped pyrochlore phase, as a further thermal barrier layer which is arranged between the substrate and the first layer or between the metal bonding layer and the first layer.

According to the invention, a pyrochlore phase doped with at least one rare earth material is thus used in particular as a thermal barrier layer with thermographic properties.

The dopant may be selected from the group Eu, Tb, Er, Dy, Sm, Ho, Pr, Yb, Nd and Tm, in which case Dy and Tm are especially suitable as dopants owing to the advantageous temperature-dependent decay behavior of their luminescent radiation. The doping concentration of the rare earth material preferably lies in the range of between 0.005% and 7%, particularly in the range of between 0.1% and 4%.

The pyrochlore phase and the rare earth material have in particular those features, properties and advantages which were explained in detail in relation to the pyrochlore phase described in the context of the layer system and the rare earth material described in the context of the layer system. Thus, the thermographic material may for example have the form (A,B)ᵥ(CₓD_{y})O_{z} with x+y≈2 and z≈7, in particular with v≈2, x+y≈2 and z≈7, more particularly with v=2, x+y=2 and z=7, where A stands for at least one rare earth material of the pyrochlore phase, B stands for at least one rare earth material as a dopant, C stands for Zr and D stands for Hf. In particular, the pyrochlore phase may comprise or consist of (Gd,B)₂Hf₂O₇ and/or (Gd,B)₂Zr₂O₇, where B stands for at least one rare earth material as a dopant.

The first layer is used for example as a thermal barrier layer for a turbine component lying in the hot gas path of a turbine, particularly for a gas turbine component, for example as a thermal barrier layer for a turbine blade or a heat shield element of a gas turbine combustion chamber.

### BRIEF DESCRIPTION OF THE DRAWINGS

Other features, properties and advantages of the invention may be found in the following description of exemplary embodiments with reference to the appended figures, in which:

FIG. 1 shows a first exemplary embodiment of a layer system according to the invention,

FIG. 2 shows a second exemplary embodiment of a layer system according to the invention,

FIG. 3 shows a third exemplary embodiment of a layer system according to the invention,

FIG. 4 shows a gas turbine

FIG. 5 shows a perspective view of a turbine blade,

FIG. 6 shows a perspective view of a combustion chamber,

### DETAILED DESCRIPTION OF INVENTION

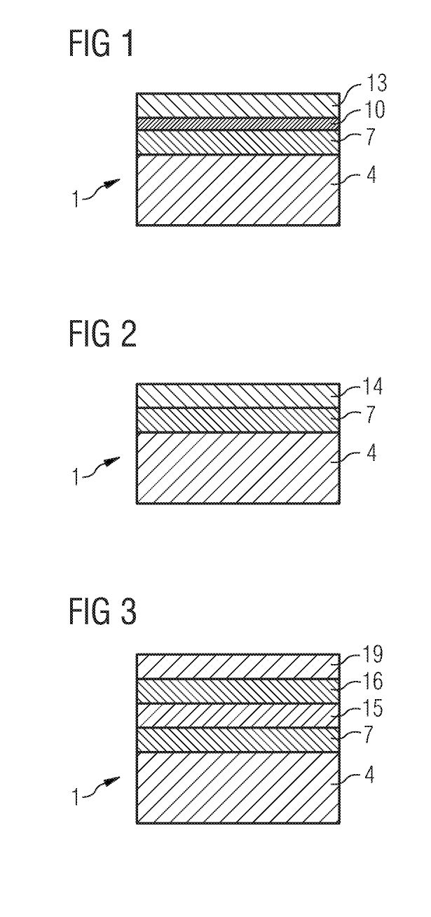

FIG. 1 shows a first exemplary embodiment of a layer system according to the invention.

The layer system 1 comprises a metal substrate 4 which, in particular for components intended to be used at high temperatures, consists of a nickel- or cobalt-based superalloy. Examples of such components are turbine components, for instance turbine blades or guide vanes of gas turbines.

Directly on the substrate 4, there is preferably a metal bonding layer 7 in particular of the MCrAlX type. This may be based on nickel and consist of 11-13 wt % cobalt, from 20 to 22 wt % chromium, from 10.5 to 11.5 wt % aluminum, from 0.3 to 0.5 wt % yttrium and from 1.5 to 2.5 wt % rhenium, the remainder being nickel, and in particular of 12 wt % cobalt, 21 wt % chromium, 11 wt % aluminum, 0.4 wt % yttrium and 2 wt % rhenium, the remainder being nickel. It may however also consist of 24-26 wt % cobalt, from 16 to 18 wt % chromium, from 9.5 to 11 wt % aluminum, from 0.3 to 0.5 wt % yttrium and from 0.5 to 2.0 wt % rhenium, the remainder being nickel, and in particular of 25 wt % cobalt, 17 wt % chromium, 10.5 wt % aluminum, 0.6 wt % yttrium and 1 wt % rhenium, the remainder being nickel.

Instead of nickel, the MCrAlX alloy may also be based on cobalt. A cobalt-based MCrAlX alloy may consist of from 29 to 31 wt % nickel, from 27 to 29 wt % chromium, from 7 to 9 wt % aluminum, from 0.5 to 0.7 wt % yttrium and from 0.6 to 0.8 wt % silicon, the remainder being cobalt, and in particular of 30 wt % nickel, 28 wt % chromium, 8 wt % aluminum, 0.6 wt % yttrium and 0.7 wt % silicon, the remainder being cobalt. In an alternative variant, the MCrAlX alloy consists of from 27 to 29 wt % nickel, from 23 to 25 wt % chromium, from 9 to 11 wt % aluminum and from 0.5 to 0.7 wt % yttrium, the remainder being cobalt, and in particular of 28 wt % nickel, 24 wt % chromium, 10 wt % aluminum and 0.6 wt % yttrium, the remainder being cobalt.

An aluminum oxide layer will already have been formed on this metal bonding layer 7 before further ceramic layers are applied, or such an aluminum oxide layer will be formed during operation (TGO).

In the present exemplary embodiment, there is an inner layer 10, preferably a fully or partially stabilized zirconium oxide layer or an undoped pyrochlore layer based on Gd₂Hf₂O₇ or Gd₂Zr₂O₇, on the metal bonding layer 7 or on the aluminum oxide layer (not shown). Yttrium-stabilized zirconium oxide is preferably used, with 6 wt %-8 wt % of yttrium preferably being employed. Calcium oxide, cerium oxide and/or hafnium oxide may likewise be used to stabilize zirconium oxide.

The zirconium oxide is applied for example as a plasma-sprayed layer, although it may also preferably be applied as a columnar structure by means of electron beam deposition (EBPVD).

An outer ceramic layer 13, which comprises a thermographic material, is applied as a first layer on the stabilized zirconium oxide layer 10. The thermographic material is a pyrochlore phase which contains Dy or Tm as doping. The doping concentration of the Dy or Tm lies in the range of between 0.1% and 4%.

The Dy or Tm is used as an activator, which induces luminescence of the doped pyrochlore phase when stimulated with UV radiation. The decay behavior of the luminescent radiation—in particular its characteristic decay time—depends on the temperature of the pyrochlore phase and thus permits temperature measurement by stimulating luminescent radiation of the doped pyrochlore phase and determining the decay behavior of the luminescence, in particular the characteristic decay time.

The pyrochlore phase in the exemplary embodiment consists of gadolinium hafnate (Gd₂Hf₂O₇) or gadolinium zirconate (Gd₂Zr₂O₇), which is doped with Dy or Tm. It may however also consist of Gdᵥ(ZrₓHf₂)O_{z} with v=2, x+y=2 and z=7. Instead of Gd or in addition to Gd, other rare earth materials may in principle also be used in the pyrochlore phase.

The rare earth material for the doping may in particular be selected from the group: Eu, Tb, Er, Dy, Sm, Ho, Pr, Yb, Nd and Tm. It may be made to react as an oxide with the host lattice (in the present exemplary embodiment Gd₂Hf₂O₇ or Gd₂Zr₂O₇), in order to form the thermographic light-emitting substance. The doping concentration may then lie in the range of between 0.005% and 7%, particularly in the range of between 0.1% and 4%. The decay behavior of the luminescent radiation of the thermographic light-emitting substance, its characteristic decay time, may be established suitably through the choice of the rare earth material for the doping. The intensity of the luminescent radiation of a particular doping material may, for example, be influenced through the doping concentration.

The layer thickness of the inner layer 10 is preferably less than 50% of the total layer thickness of the inner layer 10 plus the outer ceramic layer 13.

The inner ceramic layer 10 preferably has a thickness of from 25 μm to 100 μm, in particular 50 μm±5 μm. The total layer thickness of the inner layer 10 plus the outer layer 13 is preferably 300 μm or more, preferably 400 μm. The maximum total layer thickness is advantageously 800 μm or preferably at most 600 μm.

The layer thickness of the inner layer 10 is between 10% and 40%, preferably between 10% and 30%, of the total layer thickness.

It is likewise advantageous for the layer thickness of the inner layer 10 to comprise from 10% to 20% of the total layer thickness.

As an alternative, the layer thickness of the inner layer 10 may be between 20% and 50% or between 20% and 40% of the total layer thickness. Advantageous results are likewise achieved if the contribution of the inner layer 10 to the total layer thickness is between 20% and 30%.

The layer thickness of the inner layer 10 may however also be from 30% to 50% of the total layer thickness, in particular between 40% and 50% of the total layer thickness.

Although the outer ceramic layer 13 has better thermal barrier properties than the ZrO₂ layer, the ZrO₂ layer may be configured to be equally thick as the ceramic layer 13.

FIG. 2 shows a second exemplary embodiment of a layer system according to the invention.

Elements of the second exemplary embodiment which correspond to an element of the first exemplary embodiment are denoted by the same references as in the first exemplary embodiment and will not be explained in detail again.

The layer system 1 comprises a metal substrate 4 which, in particular for components intended to be used at high temperatures, consists of a nickel- or cobalt-based superalloy. Examples of such components are turbine components, for instance turbine blades or guide vanes of gas turbines.

Directly on the substrate 4, there is preferably a metal bonding layer 7 in particular of the MCrAlX type. As an alternative, however, an aluminum oxide layer may also be provided as a bonding layer. With respect to the composition of the MCrAlX bonding layer, the comments about the bonding layer of the first exemplary embodiment apply accordingly.

Directly on the metal bonding layer 7, a ceramic thermal barrier layer 14 is applied as a first layer. The thermal barrier layer preferably consists of doped gadolinium hafnate or doped gadolinium zirconate as a pyrochlore phase with thulium (Tm) or dysprosium (Dy) as a doping material. It may, however, also consist of other pyrochlore phases or mixtures of two or more pyrochlore phases. Likewise other dopants, for example other rare earth materials, may also be employed instead of or in addition to thulium or dysprosium. The doping concentration may lie particularly in the range of between 0.005% and 7%. In particular, the ceramic thermal barrier layer used as the outer layer may be designed like the outer layer 13 of the first exemplary embodiment. This also applies for the doping materials mentioned with reference to this outer layer 13.

FIG. 3 shows another exemplary embodiment of the layer system 1 according to the invention.

The layer system 1 again consists of a substrate 4, on which a metal bonding layer 7 is provided.

On this metal bonding layer, on which an aluminum oxide layer (TGO) is formed (not shown), there is an inner ceramic bonding layer 15, in particular partially or fully stabilized zirconium oxide, on which there is then an inner thermal barrier layer 16 of a pyrochlore phase.

On the inner thermal barrier layer 16, there is an outer thermal barrier layer 19. The outermost layer 19 is likewise made of a pyrochlore phase, in particular the same pyrochlore phase as the inner-lying layer 16, although the outer thermal barrier layer 19 is doped with a light-emitting substance such as has already been described with reference to FIGS. 1 and 2. The doping concentration may lie particularly in the range of between 0.005% and 7%, and preferably in the range of between 0.1% and 4%. In principle, any of the pyrochlore phases described above may be envisaged as the pyrochlore phase.

The thickness of the doped pyrochlore layer 19 is preferably from 2 μm to 50 μm, in particular 5-30 μm.

In the exemplary embodiments, there may in principle also be another thermal barrier layer over the doped pyrochlore layer in question, for example a zirconium oxide layer stabilized or partially stabilized with yttrium, or an undoped pyrochlore layer.

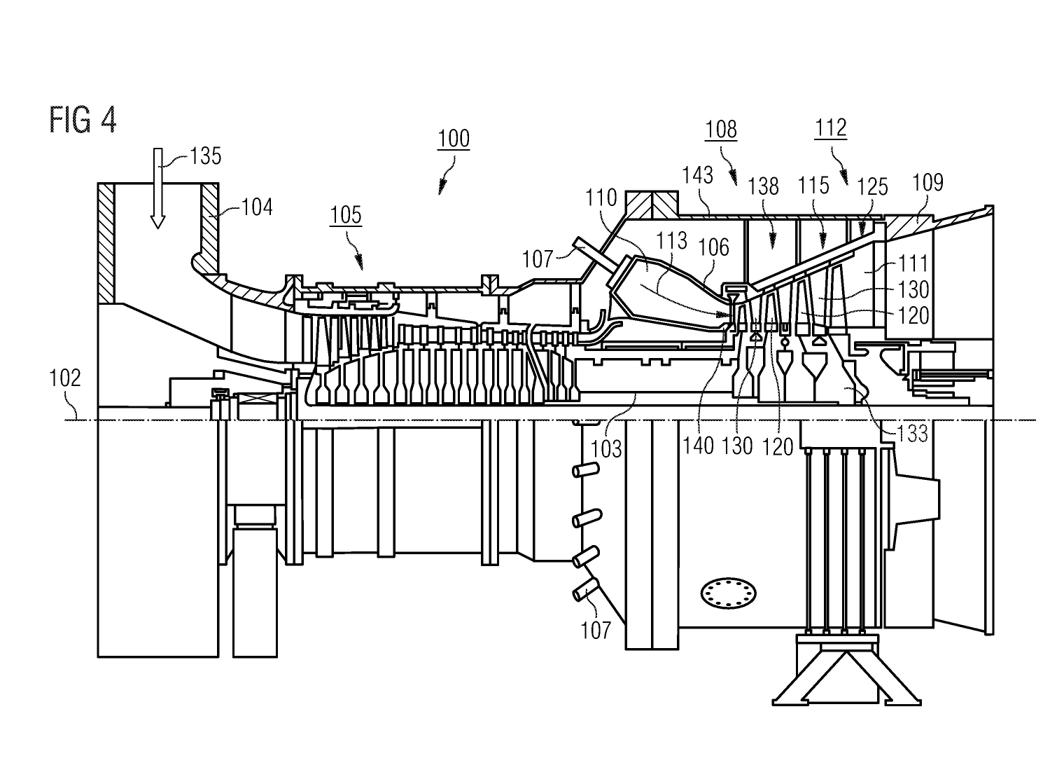

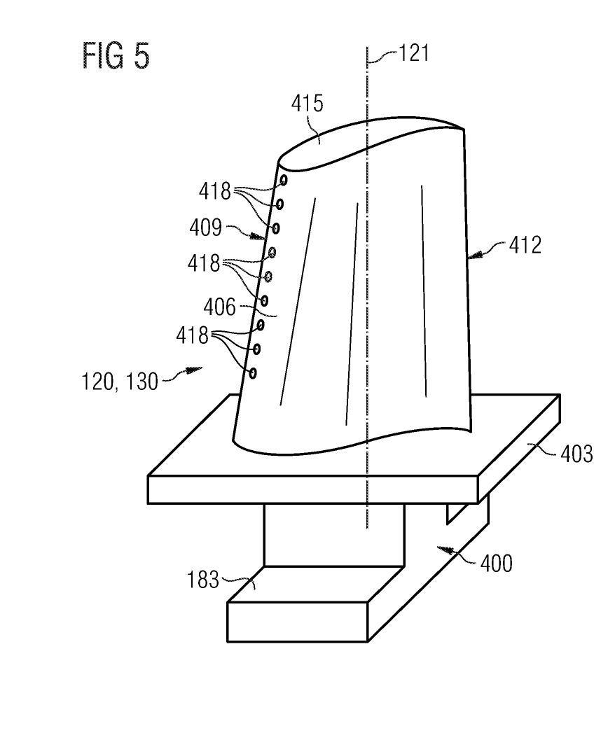

FIG. 4 shows a gas turbine 100 by way of example in a partial longitudinal section. The gas turbine 100 internally comprises a rotor 103, which will also be referred to as the turbine rotor, mounted so as to rotate about a rotation axis 102 and having a shaft 101. Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109. The ring combustion chamber 110 communicates with an e.g. annular hot gas channel 111. There, for example, four successively connected turbine stages 112 form the turbine 108. Each turbine stage 112 is fowled for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fastened on the rotor 103, for example by means of a turbine disk 133. Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 become heated. Apart from the heat shield elements lining the ring combustion chamber 110, the guide vanes 130 and rotor blades 120 of the first turbine stage 112, as seen in the flow direction of the working medium 113, are heated the most. In order to withstand the temperatures prevailing there, they may be cooled by means of a coolant. Substrates of the components may likewise comprise a directional structure, i.e. they are monocrystalline (SX structure) or comprise only longitudinally directed grains (DS structure). Iron-, nickel- or cobalt-based superalloys are for example used as material for the components, in particular for the turbine blades 120, 130 and components of the combustion chamber 110.

Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

FIG. 5 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening zone 400, a blade platform 403 adjacent thereto as well as a blade surface 406. As a guide vane 130, the vane 130 may have a further platform (not shown) at its vane tip 415.

A blade root 183 which is used to fasten the rotor blades 120, 130 on a shaft or a disk (not shown) is formed in the fastening zone 400. The blade root 183 is configured, for example, as a hammerhead. Other configurations as a firtree or dovetail root are possible. The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130. Such superalloys are known for example from EP 1 204 776 B1, EP 1 306 454, EP 1 319 729 A1, WO 99/67435 or WO 00/44949; with respect to the chemical composition of the alloy, these documents are part of the disclosure. The blades 120, 130 may in this case be manufactured by a casting method, also by means of directional solidification, by a forging method, by a machining method or combinations thereof.

Workpieces with a monocrystalline structure or monocrystalline structures are used as components for machines which are exposed to heavy mechanical, thermal and/or chemical loads during operation. Such monocrystalline workpieces are manufactured, for example, by directional solidification from the melts. These are casting methods in which the liquid metal alloy is solidified to form a monocrystalline structure, i.e. to form the monocrystalline workpiece, or is directionally solidified. Dendritic crystals are in this case aligned along the heat flux and form either a rod crystalline grain structure (columnar, i.e. grains which extend over the entire length of the workpiece and in this case, according to general terminology usage, are referred to as directionally solidified) or a monocrystalline structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or monocrystalline component. When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures. Such methods are known from U.S. Pat. No. 6,024,792 and EP 0 892 090 A1; with respect to the solidification method, these documents are part of the disclosure.

The blades 120, 130 may likewise have coatings against corrosion or oxidation, for example MCrAlX (M is at least one element from the group iron (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1 which, with respect to the chemical composition of the alloy, are intended to be part of this disclosure. The density is preferably 95% of the theoretical density. On the MCrAlX layer, i.e. the bonding layer 7, there is then ceramic thermal barrier layer 13. There may furthermore be the inner ceramic layer 10 between the MCrAlX layer and the ceramic layer 13. The thermal barrier layer covers the entire MCrAlX layer.

Rod-shaped grains are produced in the thermal barrier layer by suitable coating methods, for example electron beam deposition (EB-PVD). Other coating methods may be envisaged, for example atmospheric plasma spraying (APS), LPPS, VPS or CVD. The thermal barrier layer may comprise porous, micro- or macro-cracked grains for better shock resistance. The thermal barrier layer is thus preferably more porous than the MCrAlX layer.

The blade 120, 130 may be designed to be hollow or solid. If the blade 120, 130 is intended to be cooled, it will be hollow and optionally also comprise film cooling holes 418 (indicated by dashes).

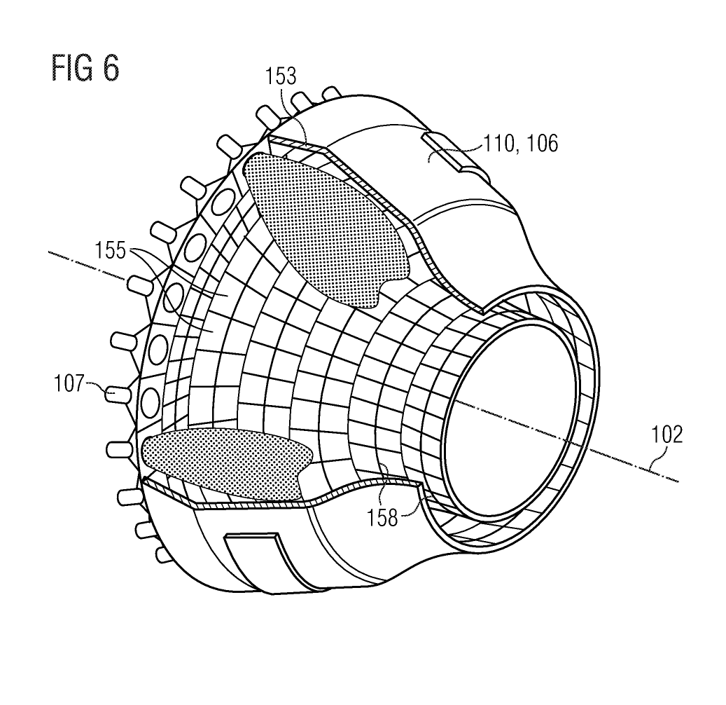

FIG. 6 shows a combustion chamber 110 of a gas turbine 100. The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Owing to the high temperatures inside the combustion chamber 110, a cooling system may also be provided for the heat shield elements 155 or for their retaining elements. The heat shield elements 155 are then hollow, for example, and optionally also have film cooling holes (not shown) opening into the combustion chamber space 154.

Each heat shield element 155 made of an alloy is equipped with a particularly heat-resistant protective layer (MCrAlX layer and ceramic coating 13, and optionally ceramic layer 10) on the working medium side. These protective layers may be similar to the turbine blades, i.e. for example MCrAlX means: M is at least one element from the group iron (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

On the MCrAlX, there is then the ceramic thermal barrier layer 13 according to the invention. Rod-shaped grains are produced in the thermal barrier layer by suitable coating methods, for example electron beam deposition (EB-PVD). Other coating methods may be envisaged, for example atmospheric plasma spraying (APS), LPPS, VPS or CVD. The thermal barrier layer may comprise porous, micro- or macro-cracked grains for better shock resistance.

Refurbishment means that turbine blades 120, 130 and heat shield elements 155 may need to have protective layers taken off (for example by sandblasting) after their use. The corrosion and/or oxidation layers or products are then removed. Optionally, cracks in the turbine blade 120, 130 or the heat shield element 155 are also repaired. The turbine blades 120, 130 or heat shield elements 155 are then recoated and the turbine blades 120, 130 or the heat shield elements 155 are used again.

1.-24. (canceled)

25. A layer system comprising:
a substrate; and
a first layer positioned on top of the substrate, the first layer comprising a thermographic material,
wherein the thermographic material is a pyrochlore phase doped with a first rare earth material,
wherein the thermographic material has a form (A,B)ᵥ(CₓD_{y})O_{z} with v≈2, x+y≈2 and z≈7, where A stands for the first rare earth material of the pyrochlore phase, B stands for a second rare earth material as a dopant, C stands for Zr and D stands for Hf,
wherein the first rare earth material and the second rare earth material are selected from the group consisting of Eu, Tb, Er, Dy, Sm, Ho, Pr, Yb, Nd and Tm, and
wherein a first doping concentration of the first rare earth material and a second doping concentration of the second rare earth material each lie in a range between 0.005% and 7.0%.

26. The layer system as claimed in claim 25, wherein the first rare earth material and the second rare earth material are Dy or Tm or a mixture thereof.

27. The layer system as claimed in claim 25, wherein the first doping concentration and the second doping concentration each lie in the range between 0.1% and 4%.

28. The layer system as claimed in claim 25, wherein the thermographic material has the form (A,B)ᵥ(CₓD_{y})O_{z} with x+y≈2 and z≈7, where A stands for the first rare earth material of the pyrochlore phase, B stands for the second rare earth material as the dopant, C stands for zirconium and D stands for hafnium.

29. The layer system as claimed in claim 25, wherein the thermographic material has the form (A,B)₂(CₓD_{y})O_{z} with x+y=2, where A stands for the first rare earth material of the pyrochlore phase, B stands for the second rare earth material as a dopant, C stands for zirconium and D stands for hafnium.

30. The layer system as claimed in claim 25, wherein the pyrochlore phase comprises or consists of (Gd,B)₂Hf₂O₇, where B stands for the second rare earth material as the dopant.

31. The layer system as claimed in claim 29, wherein the pyrochlore phase comprises or consists of (Gd,B)₂Zr₂O₇, where B stands for the second rare earth material as the dopant.

32. The layer system as claimed in claim 25, further comprising a metal bonding layer that is arranged between the substrate and the first layer.

33. The layer system as claimed in claim 32, wherein the metal bonding layer consists of a MCrAlX alloy.

34. The layer system as claimed in claim 33, wherein the MCrAlX alloy consists of from 24 to 26 weight percentage cobalt, from 16 to 18 weight percentage chromium, from 9.5 to 11 weight percentage aluminum, from 0.3 to 0.5 weight percentage yttrium and from 0.5 to 2.0 weight percentage rhenium, a remainder is nickel.

35. The layer system as claimed in claim 33, wherein the MCrAlX alloy consists of from 11 to 13 weight percentage cobalt, from 20 to 22 weight percentage chromium, from 10.5 to 11.5 weight percentage aluminum, from 0.3 to 0.5 weight percentage yttrium and from 1.5 to 2.5 weight percentage rhenium, the remainder is nickel.

36. The layer system as claimed in claim 33, wherein the MCrAlX alloy consists of from 29 to 31 weight percentage nickel, from 27 to 29 weight percentage chromium, from 7 to 9 weight percentage aluminum, from 0.5 to 0.7 weight percentage yttrium and from 0.6 to 0.8 weight percentage silicon, the remainder is cobalt.

37. The layer system as claimed in claim 33, wherein the MCrAlX alloy consists of from 27 to 29 weight nickel, from 23 to 25 weight percentage chromium, from 9 to 11 weight percentage aluminum and from 0.5 to 0.7 weight percentage yttrium, the remainder is cobalt.

38. The layer system as claimed in claim 25, further comprising a thalami barrier layer that is arranged between the substrate and the first layer or between the metal bonding layer and the first layer.

39. The layer system as claimed in claim 38, wherein the thermal barrier layer is a stabilized zirconium oxide layer or an undoped pyrochlore layer.

40. A method of a layer system comprising:
providing a pyrochlore phase doped with a rare earth material as a thermal barrier layer with a plurality of thermographic properties.

41. The method as claimed in claim 40, wherein a dopant is selected from the group consisting of Eu, Tb, Er, Dy, Sm, Ho, Pr, Yb, Nd and Tm.

42. The method as claimed in claim 41, wherein a doping concentration of the rare earth material lies in a range between 0.005% and 7%.

43. The method as claimed in claim 42, wherein the doping concentration of the rare earth material lies in the range between 0.1% and 4%.

44. The method as claimed in claim 40, wherein the thermographic material has a form (A,B)ᵥ(CₓD_{y})O_{z} with x+y≈2 and z≈7, where A stands for a first rare earth material of the pyrochlore phase, B stands for a second rare earth material as a dopant, C stands for Zr and D stands for Hf.
